(19) United States
(12) Patent Application Publication
(10) Pub. No.: US 2010/0295287 A1
(43) Pub. Date: Nov. 25, 2010

(54) SECURITY ELEMENT

(75) Inventors: Hans Reichert, Rheinfelden (DE); Veronique Hall-Goulle, Dornach (DE); Sibylle Soder, Mohlin (CH)

Correspondence Address: BASF Corporation;Patent Department, 500 White Plains Road, P.O. Box 2005, Tarrytown, NY, 10591, US

(73) Assignee: BASF SE, Tarrytown, NY (US)

(21) Appl. No.: 12/682,930

(22) PCT Filed: Oct. 22, 2008
(86) PCT No.: PCT/EP2008/064290

§ 371 Date: Aug. 11, 2010

(30) Foreign Application Priority Data
Oct. 26, 2007 (EP) 07119389.0

(51) Int. Cl. B42D 15/00; C09K 11/78; C09K 11/02; B41M 3/14; B44F 1/02

(52) U.S. Cl. 283/70; 252/301.4 R; 252/301.4 F; 252/301.6 P; 252/301.4 P; 252/301.36; 427/7; 428/29; 283/81

(57) ABSTRACT

The present invention is in the field of security documents, more particularly in the field of security elements aimed to protect security documents against copying (illegal reproduction) and counterfeiting. It discloses a security element having a coating layer(s) which changes its visual appearance after irradiation with light, especially with UV light and reverts back to the original state within a few seconds. Security documents comprising said security element, as well as a method for producing said security element, are also disclosed.

The present invention is in the field of security documents, more particularly in the field of security elements aimed to protect security documents against copying (illegal reproduction) and counterfeiting. It discloses a security element having a coating layer(s) which changes its visual appearance after irradiation with light, especially with UV light and reverts back to the original state within a few seconds. Security documents comprising said security element, as well as a method for producing said security element, are also disclosed.

Coatings, printings and markings exhibiting a viewing-angle-dependant visual appearance (“optically variable devices”, OVDs) are used as efficient anti-copy means on banknotes and security documents (cf. “Optical Document Security”, ed. R. L. van Renesse; 2^{nd} edition, 1998, Artech House, London). Among the OVDs, optically variable ink (OVI®, EP-A-O227424) holds a pre-eminent position as an “overt” security element, since its first use on a banknote back in 1987. Optically variable inks are formulated on the base of optically variable pigments (OVPs), preferably flakes of the thin-film optical interference device disclosed in U.S. Pat. No. 4,434,010; U.S. Pat. No. 5,084,351; U.S. Pat. No. 5,171,363; EP-A-227423 and in related documents.

DE102004049734 discloses a colored plastic which comprises one or more luminescent colorant and one or more transparent and/or semitransparent effect pigment. Luminescent colorants which are suitable according to DE102004049734 are all organic or inorganic luminescent dyes or pigments known to the person skilled in the art which exhibit fluorescence or phosphorescence. In Example 1 lustrous injection mouldings having a golden mass tone under daylight which exhibit red luminescence in darkness are produced by injection-moulding a mixture of thermoplastic polypropylene, Lumilux® Effect Red N100 (Riedel de Haen) and Iriodin® 355 (mica coated with titanium dioxide and iron oxide)

WO2004101890 relates to a flat dual security mark comprising two different security elements, one of which can be checked in the visible spectral region and the other in the ultraviolet spectral region of the light. Said security mark comprises plate-type effect pigments and luminescent, especially fluorescent pigments in such a low concentration that the latter can be recognised as individual particles with the naked eye under the action of UV light. The invention also relates to a method for producing said security mark and to the use of the same.

JP2002285061 provides a print the counterfeiting of which by a commercial color copying machine is very difficult. Of the print prevented from counterfeiting, at least a part of the printed area is printed with an ink for preventing counterfeiting containing a pearl pigment and a fluorescent pigment, and at the same time, at least a part is printed with an ink using the pearl pigment used for the ink for preventing counterfeiting.

WO2008067887 relates to an optically variable security element for safeguarding objects against forgery, to a method for producing a security element of this type and to the use of said element.

In Example 2 of WO2008067887 the preparation of a security element is described, comprising

a) an inner circular surface, consisting of a multilayer interference pigment on basis of mica having a colour flop from red to gold and a pigment showing a green fluorescence;

a) an outer adjacent circle, consisting of a multilayer interference pigment on basis of mica having a colour flop from gold to red and a pigment showing a red fluorescence.

At vertical observation the inner circular surface shows a red colour and the outer adjacent circle shows a gold colour. Dependant on the viewing angle the colour the inner circular surface changes to gold and the colour of the outer adjacent circle changes to red. On irradiation with UV light the inner circular surface shows a green fluorescence and the outer adjacent circle shows a red fluorescence.

Printed optically variable elements on security documents are primarily used for the “overt” authentication of security documents by the unaided human eye, through the user's checking of said element's spectral reflection properties, i.e. its color at two or more different angles of view, at least at nearorthogonal and at near grazing view with respect to the plane of the document. Said angle-dependent color is a “simple message of authenticity”, which cannot be reproduced without having access to the source of the genuine optically variable security element, and which can easily be checked by the “man on the street”.

EP1584647 describes a film material with optically variable effects comprising an absorbing or diffusely scattering layer and a layer containing optically variable pigments.

EP1669213 discloses a security element having a coating layer which appears transparent at certain angles of view, giving visual access to underlying information, whilst staying opaque at other angles of view (“Venetian Blind effect”). Documents of value, right, identity, security labels or branded goods comprising said security element, as well as a method for producing said security element, are also disclosed. Using appropriate substrate surfaces, optically variable and otherwise angle-dependent visual effects can be realized.

EP1719636 discloses a security element for a banknote, a document of value, right or identity, a ticket, a label, a branded good identifier, or a tax banderole. The element comprises a combination of a coating containing at least one optically variable pigment (P) having a substantial viewing-angle dependent colour variation, with at least one selective spectral absorbing material (A), which blocks out visible spectral components reflected by the optically variable pigment (P) at orthogonal incidence. The security element appears black when viewed at orthogonal angle, and coloured when viewed at grazing angle

US2005035331 relates to a phosphorescent blend comprising:

at least one type of persistent self-glowing material emitting in a wavelength range of less than 800 nm and greater than 400 nm with a substantial weight-mixing fraction;

at least one type of highly reflective functional pigment enhancing the effect of the said self-glowing material with a substantial weight-mixing fraction;

at least one type of substrate composite material binding the said blend with a substantial weight-mixing ration.

It was the object of the present invention to provide a security element which overcomes the drawbacks of the prior art, i.e. which displays a more evident visual colour change and which can easily be checked by the “man on the street”.

Accordingly, the present invention relates to a security element for a document of value, right, identity, for a security label or a branded good, comprising a substrate, which may contain indicia or other visible features in or on its surface, and on at least part of the said substrate surface,

comprising a pigment composition according to the present invention; or

(a) a coating layer, comprising partially, or fully an inorganic phosphorescent pigment, and

(b) a coating layer, comprising a transparent colorant, especially a transparent organic, or inorganic pigment.

Preferably, the security element comprises (a) a coating layer, comprising partially, or fully an inorganic phosphorescent pigment, and (b) a coating layer, comprising a transparent colorant, especially a transparent organic, or inorganic pigment. Usually the coating layer, comprising the transparent colorant, is applied on top of the coating layer, comprising the inorganic phosphorescent pigment. That is, in that case the security element comprises subsequently:
the substrate,
the coating layer, comprising the inorganic phosphorescent pigment, and
the coating layer, comprising the transparent colorant.

The mode of operation of the security element of the present invention is described on basis of a transparent organic pigment as colorant and an inorganic phosphorescent substance, but is not limited thereto.

At least part of a substrate is coated with a layer (first layer), comprising the inorganic phosphorescent substance. On top of the first layer is coated a second layer, comprising the transparent organic pigment.

The coating comprising the inorganic phosphorescent substance can have a form. The form may be, for example, a symbol, a stripe, a geometric form, a fancy emblem, a writing, an alphanumeric character, a depiction of an object, or a part thereof.

When the phosphorescent inorganic substance is excited by UV light, the visual appearance of the system, comprising the phosphorescent inorganic substance and the transparent colorant, changes because of the phosphorescence of the phosphorescent inorganic substance. Within a few seconds the visual appearance reverts back to its original state. Said colour change is a “simple message of authenticity”, which can be checked by the unaided human eye.

A better effect is achieved, if only part of the first layer is excited by UV light. Said part changes its visual appearance, whereas the visual appearance of the residual part is unchanged. Said colour change can be checked by the unaided human eye by simply covering part of the first layer, for example, with the thumb and irradiation with UV light. The part covered with the thumb remains unchanged, whereas the residual part changes its visual appearance. By removal of the thumb the unchanged residual part of the first layer appears, which is different to the excited part in visual appearance. The effect is visually detectable.

If the first layer is excited by UV-A light, part of the second layer can be coated with a UV-A absorber. The part of the second layer covered with the UV-A absorber doesn't change its visual appearance when excited with UV-A light.

In a particularly preferred embodiment of the present invention the UV-A absorber is coated in form of a logo on the second surface and the logo becomes visible, when excited with UV-A light.

A similar effect can be achieved, when the inorganic phosphorescent compound is only contained in part of the first layer, so that it forms also a logo. The logo becomes visible, when excited with UV-A light.

In case the inorganic phosphorescent compound is only contained in part of the first layer, the residual part of the first layer may need to contain a compound which is metameric to the inorganic phosphorescent compound, so that the security element of the present invention has a uniform visual appearance.

The change of the visual appearance of the system can in practice be achieved in one of the following ways: i) by the addition of a transparent colorant to a composition of the phosphorescent inorganic substance, such as an ink comprising said phosphorescent inorganic substance; ii) by overprinting/coating a phosphorescent coating with a second coating composition comprising the transparent colorant; or iii) by applying over said phosphorescent coating a foil or decal, comprising a transparent colorant.

The respective amount of phosphorescent inorganic pigment and transparent colorant are chosen according to the desired optical effect, provided however that the visual color change underlying the present invention remains observable. Typical amounts to be used are in the range of: 80-99.99 wt.-%, preferably 90-99.99 wt.-% of said phosphorescent inorganic pigment; and 0.01-20 wt.-%, preferably 0.01-10 wt.-% of said transparent organic colorant, based on the amount of phosphorescent inorganic pigment and transparent colorant. Typical amounts of transparent inorganic colorant to be used are in the range of: 10-40 wt.-%.

To further increase the counterfeit resistance of the herein disclosed security element, the coating(s) and/or said foil or decal can be made to exhibit additional properties, such as magnetism, infrared absorption, etc. This can be achieved by adding at least one material selected from the group consisting of the magnetic materials, and the infrared absorbing materials, to at least one portion of said security element.

Another way to use the color-changing security element of the present invention is to apply it close to a not color-shifting element having a similar visual appearance before excitation of the phosphorescent inorganic substance, such that the perceived color change after excitation of the phosphorescent inorganic substance appears enhanced.

Furthermore, the security element according to the invention can be combined with, or applied in the form of indicia of any type. Said indicia can hereby be produced through printing, laser marking, magnetic orientation, etc.

The coatings of the invention can be applied using the printing methods known in the art, such as engraved steel plate (intaglio), silkscreen, gravure, offset, letterpress- or flexographic printing. For applying a foil or decal the generally known methods of heat- or cold-stamping can be used.

The object of value to which the security element is applied may be for example a security paper, a security document, a textile garnet, or else a product package. Other objects of value that require security-type protection can of course also be provided with the inventive security element. Said security document is preferably selected from the group of documents consisting of banknotes, documents of value, right or identity, labels, branded good identifiers, and tax banderoles.

The security element is produced by a method, comprising the steps of

a) providing a substrate having a surface, which surface may contain indicia or other visible features;

b) applying, on top of at least part of the said substrate surface a coating, comprising an inorganic phosphorescent pigment (substance), a transparent colorant and a curable transparent binder, and

(c) curing said coating layer; or

a) providing a substrate having a surface, which surface may contain indicia or other visible features;

b) applying, on top of at least part of the said substrate surface a coating, comprising an inorganic phosphorescent pigment (substance) and a (curable) transparent binder,

b1) optionally curing said coating layer (b);

b2) applying, on top of said coating layer (b) a coating, comprising a transparent colorant and a curable transparent binder, and

(c) curing said coating layer(s).

Said coating layer(s) is preferably applied by a method chosen from screen printing, gravure/flexo printing, offset printing, or roller coating.

Said coating layer(s) may furthermore comprise additional security elements such as infrared luminescent compounds, infrared absorbing compounds, and magnetic substances.

Said indicia can be applied onto said substrate surface by a method selected from the group consisting of intaglio printing, letterpress printing, offset printing, screen printing, gravure/flexo printing, laser printing, laser marking, dye sublimation, and ink-jet printing.

In certain embodiments, e.g. security elements that are exposed to high mechanical or chemical load during use, it is expedient to provide the security element with a protective layer. The protective layer can be a foil laminated over the security element, or a protective lacquer layer. The protective lacquer layer can be applied all over or in partial areas. For the lacquer system one can use e.g. UV lacquers, hybrid lacquers, oleographic lacquers or dispersion lacquers of the one- or two-component type. The protective lacquer layer is preferably printed on, e.g. by flexography or offset printing.

The phosphorescent layer can also have a plurality of inorganic phosphorescent pigments with different phosphorescent colours. It is likewise possible to compose the phosphorescent layer of a plurality of phosphorescent layers containing different inorganic phosphorescent pigments with different phosphorescent colour.

The pigment composition, or pigment mixture used in the security element of the present invention is new.

Accordingly, the present invention relates also to a pigment composition, or pigment mixture, comprising

(A) an inorganic phosphorescent pigment (substance), and

(B) a transparent colorant, especially an organic, or inorganic pigment.

The respective amount of phosphorescent inorganic pigment and transparent colorant are chosen according to the desired optical effect, provided however that the visual color change underlying the present invention remains observable. Typical amounts to be used are in the range of: 80-99.99 wt.-%, preferably 90-99.99 wt.-% of said phosphorescent inorganic pigment; and 0.01-20 wt.-%, preferably 0.01-10 wt.-% of said transparent organic colorant, based on the amount of phosphorescent inorganic pigment and transparent colorant. Typical amounts of transparent inorganic colorant to be used are in the range of: 10-40 wt.-%.

The two components A and B may be mixed to form a pigment composition (physical mixture).

Alternatively, component A may be coated, or deposited onto component B.

A pigment mixture (composite pigment) may also be prepared by a process comprising spray-drying an aqueous suspension consisting of discrete particles of component A and B (cf. U.S. Pat. No. 5,562,763).

The component B may be added to a slurry of a component B in an organic solvent such as ethylene glycol or isopropanol. The obtained slurry is treated with ultrasound for 5 minutes to 2 hours, filtered and dried. The final product may be calcined and further coated with for example a protective layer such as SiO₂. Reference is made, for example, to U.S. Pat. No. 5,407,746. Component B may be trapped in a metal oxide layer, such as a silicon oxide, or an aluminum oxide layer, additionally precipitated on component A. The process for the preparation of such particles involves the precipitation of the metal oxide onto component A in the presence of component B.

A pigment mixture can also be prepared as described in U.S. Pat. No. 4,772,331 by admixing a suspension or solution of component B and a high molecular weight organic compound in water and/or an alcohol with a suspension of component A in a solution of a high molecular weight organic compound in water and/or alcohol whereby said component B is precipitated onto the surface of said component A and bound thereto by said high molecular weight organic compound.

Alternatively, component A with a surface modified by component B may be obtained as described in WO2005/056696 by trapping component B in one or several layers of immobilised LCST and/or UCST polymers.

The LCST (LCST=lower critical solution temperature) polymers may be selected from polyalkylenoxide derivatives, olefinic modified PEO-PPO-co-polymers, polymethylvinylether, poly-N-vinylcaprolactam, ethyl-(hydroxyethyl)-cellulose, poly-(N-isopropylacrylamide) and polysiloxanes and mixtures thereof.

The UCST (UCST=Upper Critical Solution Temperature) polymers may be selected from polystyrol, polystyrol-copolymers and polyethylenoxide-copolymers and mixtures thereof.

The substrate is contacted with a solution from a polymer that has UCST properties and a layer is deposited on the surface of the substrate by reducing the temperature of the polymer solution (WO03014229).

In the context of the present invention, “transparent” is used in the sense of “allowing the human eye to see through, at least in some part of the visible spectrum”.

In another aspect the present invention is directed to a coating, or a film material, comprising

(a) a layer, comprising a pigment composition according to the present invention, wherein the pigment composition is present in at least part of said layer; or

(a) a layer, comprising an inorganic phosphorescent pigment, wherein the inorganic phosphorescent pigment is present in at least part of said layer, and

(b) a layer comprising a transparent colorant, especially a transparent organic, or inorganic pigment.

The content of the phosphorescent substance in the total composition that constitutes the luminous ink without the solvent, is 1 to 60% by weight, preferably from 1 to 40% by weight. The content of the transparent organic substance in the total composition that constitutes the luminous ink without the solvent, is 0.01 to 20% by weight, preferably from 0.01 to 10% by weight. The content of the transparent inorganic substance in the total composition that constitutes the luminous ink without the solvent, is from 1 to 40% by weight.

The content of the pigment mixture in the total composition that constitutes the luminous ink without the solvent, is 1 to 60% by weight, preferably from 1 to 40% by weight.

A phosphorescent ink according to the present invention comprises, as in the case of an ordinary printing ink, a phosphorescent inorganic substance, a vehicle, an auxiliary agent, and the like.

It is further preferable to apply a surface treatment to the phosphorescent substance in order to improve the properties of the phosphorescent substance (hiding power, coloring ability, oil absorbing ability, durability, and the like). In case wherein an inorganic phosphorescent substance is used, it is preferable to apply a surface treatment thereto to improve its affinity to an oleophilic polymer, since its surface is hydrophilic and hence is of a poor affinity to an oleophilic polymer. Such methods for example include the following methods.

(a) Coating: Coating functions as a kind of a surfactant. For example, a dispersing agent including fatty acids and fatty acid salts of a low molecular weight or a high molecular weight, a dispersing agent of wax, or the like may be used.

(b) Coupling agent: A coupling agent tightly bonds with the phosphorescent substance and reacts with a polymer as well. For example a silane compound, a titanium compound, a metallic chelate compound, or the like, may be used.

(c) Polymerizable monomer: A low molecular weight monomer or oligomer is made to react with the surface of the phosphorescent substance to form an irreversible layer. For example, a polymerizable organic acid, or a reactive oligomer may be used.

With respect to the vehicle of the luminous ink according to the present invention, one that does not substantially have an absorption band in the wavelength range of ultraviolet light that excite the fluorescent substance and in the wavelength range of visible light is preferred. With respect to the binder resin which is a principal constituent of the vehicle, a thermoplastic resin may be used, examples of which include, polyethylene based polymers [polyethylene (PE), ethylene-vinyl acetate copolymer (EVA), vinyl chloride-vinyl acetate copolymer], polypropylene (PP), vinyl based polymers [poly(vinyl chloride) (PVC), poly(vinyl butyral) (PVB), poly(vinyl alcohol) (PVA), poly(vinylidene chloride) (PVdC), poly(vinyl acetate) (PVAc), poly(vinyl formal) (PVF)], polystyrene based polymers [polystyrene (PS), styrene-acrylonitrile copolymer (AS), acrylonitrile-butadiene-styrene copolymer (ABS)], acrylic based polymers [poly(methyl methacrylate) (PMMA), MMA-styrene copolymer], polycarbonate (PC), celluloses [ethyl cellulose (EC), cellulose acetate (CA), propyl cellulose (CP), cellulose acetate butyrate (CAB), cellulose nitrate (CN)], fluorin based polymers [polychlorofluoroethylene (PCTFE), polytetrafluoroethylene (PTFE), tetrafluoroethylene-hexafluoroethylene copolymer (FEP), poly(vinylidene fluoride) (PVdF)], urethane based polymers (PU), nylons [type 6, type 66, type 610, type 11], polyesters (alkyl) [polyethylene terephthalate (PET), polybutylene terephthalate (PBT), polycyclohexane terephthalate (PCT)], novolac type phenolic resins, or the like. In addition, thermosetting resins such as resol type phenolic resin, a urea resin, a melamine resin, a polyurethane resin, an epoxy resin, an unsaturated polyester and the like, and natural resins such as protein, gum, shellac, copal, starch and rosin may also be used.

Further, the above resins may be in an emulsion form for use in a water-based paint. Emulsions for use in a water-based paint include for example, a vinyl acetate (homopolymer) emulsion, a vinyl acetate-acrylic ester copolymer emulsion, a vinyl acetate-ethylene copolymer emulsion (EVA emulsion), a vinyl acetate-vinyl versatate copolymer resin emulsion, a vinyl acetate-polyvinyl alcohol copolymer resin emulsion, a vinyl acetate-vinyl chloride copolymer resin emulsion, an acrylic emulsion, an acryl silicone emulsion, a styrene-acrylate copolymer resin emulsion, a polystyrene emulsion, an urethane polymer emulsion, a polyolefin chloride emulsion, an epoxy-acrylate dispersion, an SBR latex, and the like.

Furthermore, to the vehicle, a plasticizer for stabilizing the flexibility and strength of the print film and a solvent for adjusting the viscosity and drying property thereof may be added according to the needs therefor. A solvent of a low boiling temperature of about 100° C. and a petroleum solvent of a high boiling temperature of 250° C. or higher, may be used according to the type of the printing method. An alkylbenzene or the like, for example may be used as a solvent of a low boiling temperature.

Further in addition, an auxiliary agent including a variety of reactive agents for improving drying property, viscosity, and dispersibility, may suitably be added. The auxiliary agents are to adjust the performance of the ink, and for example, a compound that improves the abrasion resistance of the ink surface and a drying agent that accelerates the drying of the ink, and the like may be employed.

A photopolymerization-curable resin or an electron beam curable resin wherein a solvent is not used may also be employed as a binder resin that is a principal component of the vehicle. The examples thereof include an acrylic resin, and specific examples of acrylic monomers commercially available are shown below.

A monofunctional acrylate monomer that may be used includes for example, 2-ethylhexyl acrylate, 2-ethylhexyl-EO adduct acrylate, ethoxydiethylene glycol acrylate, 2-hydroxyethyl acrylate, 2-hydroxypropyl acrylate, 2-hydroxyethyl acrylate-caprolactone adduct, 2-phenoxyethyl acrylate, phenoxydiethylene glycol acrylate, nonyl phenol-EO adduct acrylate, (nonyl phenol-EO adduct)-caprolactone adduct acrylate, 2-hydroxy-3-phenoxypropyl acrylate, tetrahydrofurfuryl acrylate, furfuryl alcohol-caprolactone adduct acrylate, acryloyl morpholine, dicyclopentenyl acrylate, dicyclopentanyl acrylate, dicyclopentenyloxyethyl acrylate, isobornyl acrylate, (4,4-dimethyl-1,3-dioxane)-caprolactone adduct acrylate, (3-methyl-5,5-dimethyl-1,3-dioxane)-caprolactone adduct acrylate, and the like.

A polyfunctional acrylate monomer that may be used includes hexanediol diacrylate, neopentyl glycol diacrylate, polyethylene glycol diacrylate, tripropylene glycol diacrylate, neopentyl glycol hydroxypivalate diacrylate, (neopentyl glycol hydroxypivalate)-caprolactone adduct diacrylate, (1,6-hexanediol diglycidyl ether)-acrylic acid adduct, (hydroxypivalaldehyde-trimethylolpropane acetal) diacrylate, 2,2-bis[4-(acryloyloxydiethoxy)phenyl]propane, 2,2-bis[4-(acryloyloxydiethoxy)phenyl]methane, hydrogenated bisphenol A-ethylene oxide adduct diacrylate, tricyclodecanedimethanol diacrylate, trimethylolpropane triacrylate, pentaerithritol triacrylate, (trimethylolpropane-propylene oxide) adduct triacrylate, glycerine-propylene oxide adduct triacrylate, a mixture of dipentaerithritol hexaacrylate and pentaacrylate, esters of dipentaerithritol and lower fatty acid and acrylic acid, dipentaerithritol-caprolactone adduct acrylate, tris(acryloyloxyethyl) isocyanurate, 2-acryloyloxyethyl phosphate, and the like.

Inks comprising the above resins are free of solvent and are so constituted as to polymerize in chain reaction upon irradiation by an electron beam or electromagnetic waves.

With respect to inks of ultraviolet-irradiation type among these inks, a photopolymerization initiator, and depending on the needs therefor, a sensitizing agent, and auxiliary agents such as a polymerization inhibitor and a chain transfer agent, and the like may be added thereto.

With respect to photo-polymerization initiators, there are, (1) an initiator of direct photolysis type including an arylalkyl ketone, an oxime ketone, an acylphosphine oxide, or the like, (2) an initiator of radical polymerization reaction type including a benzophenone derivative, a thioxanthone derivative, or the like, (3) an initiator of cationic polymerization reaction type including an aryl diazonium salt, an aryl iodinium salt, an aryl sulfonium salt, and an aryl acetophenone salt, or the like, and in addition, (4) an initiator of energy transfer type, (5) an initiator of photoredox type, (6) an initiator of electron transfer type, and the like. With respect to the inks of electron beam-curable type, a photopolymerization initiator is not necessary and a resin of the same type as in the case of the ultraviolet-irradiation type inks can be used, and various kinds of auxiliary agent may be added thereto according to the needs therefor.

A further aspect of the present invention relates to a phosphorescent image formed by printing an inorganic phosphorescent pigment (substance), and a transparent colorant on a substrate, comprising a phosphorescent image-forming layer on said substrate, or a phosphorescent image-forming layer and a colored transparent layer on said substrate, wherein

the phosphorescent image-forming layer comprises an inorganic phosphorescent pigment (substance) and optionally a transparent colorant, and

the colored transparent layer comprises a transparent colorant.

The phosphorescent image formed product according to the present invention can be obtained by forming a phosphorescent image forming layer on a substrate using the phosphorescent ink by a variety of methods known in the art. For example, an anastatic printing method, an intaglio printing method, a gravure printing method, a planographic printing method of offset printing type, a screen (perforated plate) printing method, a relief type printing method such as flexo or letter press printing or the like may be used. In addition, a thermal transfer method or an ink jet printing method may be used as well. In case of using a thermal transfer method, it is preferable to maintain enough amount of light by keeping the thickness of the fluorescent image-forming layer at least equal to or higher than 6 μm, and hence it is preferable to add a binder or a wax such as carbana wax to the image-forming layer. Since it is preferable to thermally melt the surface of the ink, it is preferable to use a thermoplastic resin as a binder resin, which is a principal component of the vehicle.

The thickness of the phosphorescent image-forming layer can be somewhere between 1 and 200 μm.

The film material is preferably a transfer film material. The transfer film material has an adhesive layer which allows its transfer to a substrate. The transfer film material can be used for the production of security labels for data processing media, documents of value, right, identity, branded goods, etc.

As substrate materials there may be mentioned, for example:
cellulose-containing materials, such as paper, pasteboard, cardboard, wood and wooden materials, which may also be lacquered or coated in some other way,
metallic materials, such as foils, sheet metal or workpieces of aluminium, iron, copper, silver, gold, zinc or alloys of those metals, which may be lacquered or coated in some other way,
silicate materials, such as glass, porcelain and ceramics, which may likewise be coated,
polymeric materials of any kind, such as polystyrene, polyamides, polyesters, polyethylene, polypropylene, melamine resins, polyacrylates, polyacrylonitrile, polyurethanes, polycarbonates, polyvinyl chloride and corresponding copolymers and block copolymers,
textile materials, such as fibres, yarns, twisted yarns, knitted goods, wovens, non-wovens and made-up goods of polyester or of modified polyester, polyester blends, cellulose-containing materials, such as cotton, cotton blends, jute, flax, hemp and ramie, viscose, wool, silk, polyamide, polyamide blends, polyacrylonitrile, triacetate, acetate, polycarbonate, polypropylene, polyvinyl chloride, polyester microfibres and glass fibre fabrics,
leathers, both natural leather and synthetic leather, in the form of smooth-finished leather, nappa leather or velour leather.

The transparent pigment is selected from the group consisting of transparent organic pigments, or inorganic pigments, including color and/or effect pigments, electrically conductive pigments, fluorescent pigments, fillers, nanoparticles, and combinations thereof.

In a preferred embodiment of the present invention the transparent pigment is a transparent organic pigment, or a transparent inorganic colour pigment.

The transparent organic pigment is preferably a transparent organic pigment having a mean particle size below 0.2 μm, preferably below 0.1 μm. Particularly interesting organic transparent pigments include the transparent quinacridones in their magenta and red colors, the transparent yellow pigments, like the isoindolinones or the yellow quinacridone/quinacridonequinone solid solutions, transparent copper phthalocyanine blue and halogenated copper phthalocyanine green, or the highly-saturated transparent diketopyrrolopyrrole or dioxazine pigments; especially a transparent quinacridone pigment or a transparent diketopyrrolopyrrole pigment.

Examples of commercially available products are MICROLITH DPP Red B-K, IRGAZIN DPP Red BTR, CROMOPHTAL Yellow GR, CROMOPHTAL Orange GP, CROMOPHTAL DPP Rot BP, CROMOPHTAL Violet GP, CROMOPHTAL Blue A3R, IRGAZIN Green 2180 and ORASOL Black RLI (Ciba Specialty Chemicals).

The expression “inorganic filler” means a substantially transparent inorganic pigment. For example, mica, kaolin, talc, wollastonite and natural or synthetic silica, e.g. glass, are well-known inorganic fillers that are suitable for use in the pigment compositions of the present invention. Talc, muscovite mica and kaolin are highly suitable inorganic fillers. Talc and transparent micas are especially suitable. Of the micas, muscovite, phlogopite, brolite and synthetic micas are the most suitable.

In another preferred embodiment of the present invention the transparent pigment is an effect pigment.

Multilayered structures leading to interference colors are often referred to as special-effect pigments, luster or nacreous pigments and well known in the art and commercially available under such tradenames as Xymara® (Ciba Specialty Chemicals Inc.), Iriodin®, Colorstream®, Xyrralic® etc.

In principle component B might comprise all platelet-like transparent effect pigments, such as, for example, platelet-like materials coated with colored or colorless metal oxides, such as, for example, natural or synthetic micas, other laminated silicates such as talc, kaolin or sericite or glass platelets. Mica flakes coated with metal oxides which are disclosed, for example, in U.S. Pat. Nos. 3,087,828 and 3,087,829 are particularly preferred as substrates. Metal oxides are both colorless, highly refractive metal oxides, such as, in particular, titanium dioxide and/or zirconium dioxide, as well as colored metal oxides, such as, for example, chromium oxide, nickel oxide, copper oxide, cobalt oxide and in particular iron oxides, such as, for example, Fe₂O₃, or mixtures of such metal oxides. Such metal oxide/mica pigments are commercially available under the tradenames Xymara®, Afflair® and Iriodin®.

These (multilayer) structures frequently are formed from a core of natural micaceous iron oxide (for example as in WO 99/48634), synthetic and doped micaceous iron oxide (for example as in EP-A 0 068 311), mica (muscovite, phlogopite, fluorophlogopite, synthetic fluorophlogopite, talc, kaolin), basic lead carbonate, flaky barium sulfate, SiO₂, Al₂O₃, TiO₂, glass, ZnO, ZrO₂, SnO₂, BiOCl, and flaky MgO. Particularly preferred cores are mica, SiO₂ flakes, Al₂O₃ flakes, TiO₂ flakes, BiOCl and glass flakes.

Transparent pearlescent pigments (including those which react under the fluidized bed conditions to nitrides, oxynitrides or by reduction to suboxides etc.) are, for example, described in EP-A-0948571, U.S. Pat. Nos. 6,773,499, 6,508,876, 5,702,519, 5,858,078, WO98/53012, WO97/43348, U.S. Pat. No. 6,165,260, DE-A-1519116, WO97/46624 and EP-A-0509352. Transparent pearlescent multilayer pigments are, for example, described in EP-A-0948572, EP-A-0882099, U.S. Pat. Nos. 5,958,125, 6,139,613. Transparent coated, or uncoated SiO₂ spheres are, for example, known from EP-A-0803550, EP-A-1063265, JP-A-11322324), EP-A-0803550, EP-A-1063265 and JP-A-11322324.

The glass flake cores for the purpose of the invention include any of the known grades such as A-glass, E-glass (high resistivity makes E-glass suitable for electrical lami nates), C-glass and ECR-glass (corrosion grade glass) materials.

For example, component B particle may be a platelet-like (multilayered) structures such as:

| | | | |
|---|---|---|---|
| TRASUB | TiO₂ | | |
| TRASUB | TiO₂ | Fe₂O₃ | |
| TRASUB | TiO₂ | SiO₂ | |
| TRASUB | TiO₂ | SiO₂ | TiO₂ |
| TRASUB | TiO₂ | SiO₂ | Fe₂O₃ |
| TRASUB | TiO₂ | SiO₂ | TiO₂/Fe₂O₃ |
| TRASUB | SnO₂ | TiO₂ | |
| TRASUB | SnO₂ | TiO₂ | Fe₂O₃ |
| TRASUB | TiO₂/Fe₂O₃ | SiO₂ | TiO₂/Fe₂O₃ |
| TRASUB | Fe₂O₃ | | |
| TRASUB | Fe₂O₃ | SiO₂ | TiO₂ |
| TRASUB | TiO₂ | SiO₂ | TiO₂ + SiO₂ + TiO₂ |
| TRASUB | TiO₂ + SiO₂ + TiO₂ | SiO₂ | TiO₂ + SiO₂ + TiO₂ |
| TRASUB | TiO₂ | Al₂O₃ | TiO₂ |
| TRASUB | Fe₂TiO₅ | SiO₂ | TiO₂ |
| TRASUB | TiO₂ | SiO₂ | Fe₂TiO₅/TiO₂ |
| TRASUB | TiO₂ | SiO₂ | MoS₂ |
| TRASUB | TiO₂ | SiO₂ | Cr₂O₃ |
| TRASUB | TiO₂ | SiO₂ | TiO₂ + SiO₂ + TiO₂ + |
| | | | Prussian Blue |

wherein TRASUB is transparent substrate having a low index of refraction selected from the group consisting of natural, or synthetic mica, another layered silicate, glass, Al₂O₃ and SiO₂.

The (multilayered) pigments above may also include an absorption pigment as an additional layer. For example a further coating with Prussian blue or red-carmine on an interference pigment allows for striking color effects.

If the used effect pigments are goniochromatic, the security element of the present invention will also show a so-called flip-flop effect, i.e. a color change depending on the viewing angle.

Examples of transparent inorganic pigments are transparent yellow iron oxide [C.I. Pigment Yellow 42:77 492], transparent red iron oxide [C.I. Pigment Red 101:77 491], transparent Cobalt Blue [C.I. Pigment Blue 28 : 77 346], transparent Cobalt Green [C.I. Pigment Green 19:77 335].

Examples of commercially available products are BAYFERROX 3920, BAYFERROX 920 BAYFERROX 645T, BAYFERROX 303T, BAYFERROX 110, BAYFERROX 110 M, CHROMOXIDGRUEN GN, and CHROMOXIDGRUEN GN-M.

In principle, any inorganic phosphorescent substance can be used according to the present. Examples of preferred substances are given below. The decay time of the inorganic phosphorescent substance should be preferably in the range of a few seconds. It should be noted that the decay time is dependent on the particle size and the particle size distribution of the substances.

Inorganic phosphorescent substances emitting visible light are, for example, described in EP-A1-0622440.

The inorganic phosphorescent substances described therein comprise a matrix of formula MAl₂O₄ wherein M is calcium, strontium or barium, or a matrix of formula (M′xM″y)Al₂O₄ wherein x+y=1 and M′ and M″, which are different, are each a metal selected from calcium, barium, strontium and magnesium. The matrix comprises europium as activator. The matrix comprises, as co-activator, at least one element selected from lanthanum, cerium, praseodymium, neodymium, samarium, gadolinium, terbium, dysprosium, holmium, erbium, thulium, ytterbium, lutetium, manganese, tin and bismuth.

The matrix comprises europium in an amount of 0.001 to 10 mol % relative to the metal or metals in the matrix. The co-activator is comprised in an amount of 0.001 to 10 mol % relative to the metal or metals in the matrix.

A list of phosphorescent inorganic materials, which can advantageously be used according to the present invention, is given below:

| Formula | Emission Color |
|---|---|
| CaO:Eu³⁺ | orange |
| CaO:Tb³⁺ | green |
| SrO:Pb²⁺ | violet |
| SrO:Eu³⁺ | orange |
| SrO:Tb³⁺ | green |
| BaO:Eu³⁺ | red |
| Y₂O₂S:Ti⁴⁺,Mg²⁺ | |
| (Y_{2-x-y}TixMg_{y})O₂S | yellow-orange |
| Y₂O₂S:Sm²⁺,Ti⁴⁺,Mg²⁺ | red |
| Y₂O₂S:Eu³⁺,Ti⁴⁺,Mg²⁺ | red |
| Y₂O₂S:Tm³⁺,Ti⁴⁺,Mg²⁺ | bluegreen |
| Y₂O₂S:Yb³⁺,Ti⁴⁺,Mg²⁺ | |
| Y₂O₂S:Eu³⁺,Ti⁴⁺ | red |
| Y₂O₂S | |
| Y₂O₂S:RE³⁺(RE:Lu/Gd) | green |
| Y₂O₂S:Tb³⁺ | white: |
| ,Sr²⁺ and/or Zr⁴⁺ | blue and yellow- |
| | green |
| Y₂O₂S:Tm³⁺ | orange-yellow |
| Gd₂O₂S:Er³⁺,Ti⁴⁺ | |
| CaS:Eu²⁺,Ce³⁺ | |
| CaS:Eu²⁺,Sm³⁺ | |
| CaS:Eu²⁺,Tm³⁺ | red |
| CaS:Eu²⁺,Tm³⁺,Ce³⁺ | red |
| (Ca,Sr)S:Bi³⁺ | blue |
| CaGa₂S₄:Eu²⁺,Ho³⁺ | yellow |
| CaGa₂S₄:Eu²⁺,RE³⁺ | |
| (RE:Y/Ce/Pr/Gd/Tb/Ho) | |
| SrS:Eu²⁺,Y³⁺,Ce³⁺ | orange |
| ZnS:Cu | yellow-green |
| ZnS:Cu,Co | yellow-green |
| Zn₄O(BO₂)₆ | violet |
| CaAl₂B₂O₇:Eu²⁺,Nd³⁺ | blue |
| MgAl₂O₄:Ce³⁺ | green |
| CaAl₂O₄:Mn²⁺,Ce³⁺ | green |
| CaAl₂O₄:Eu²⁺,Nd³⁺ | blue |
| Ca_{1-x-y}Al₂O₄:Euₓ²⁺,Nd_{y}³⁺ | blue |
| (0 ≦ x ≦ 0.045; 0 ≦ y ≦ 0.0037) | |
| opt.: x = 0.00125; y = 0.0025 | |
| CaAl₂O₄:Eu²⁺,Nd³⁺ | blue |
| CaAl₂O₄:Eu²⁺,Nd³⁺,La³⁺ | blue-violet |
| CaAl₄O7:Eu²⁺,Nd³⁺ | |
| Ca1 − xSrxAl₂O₄:Eu²⁺,Nd³⁺,La³⁺ | |
| SrAl₂O₄:Ce³⁺ | |
| SrAl₂O₄:Eu²⁺ | green |
| SrAl₂O₄:Eu²⁺,B³⁺ | green |
| SrAl₂O₄:Eu²⁺,Nd³⁺ | |
| SrAl₂O₄:Eu²⁺,Dy³⁺ | green |
| MAl₂O₄:Eu²⁺,Dy³⁺M:Sr, (Ba/Ca) or M:Sr,Ba,Ca | f(m) |
| Sr₄Al₁₄O₂₅:Eu²⁺,RE³⁺RE:Dy/Pr/Ho/Nd and/or Sm | |
| Sr₄Al₁₄O₂₅:Cr³⁺,Eu²⁺,Dy³⁺ | red-blue |
| Sr₅Al₂O₇S:Eu²⁺ | |
| Y₃Ga₅O₁₂:Cr³⁺ | |
| MgSiO₃:Mn²⁺,Eu²⁺,Dy³⁺ | red |
| SrSiO₃:Dy³⁺ | white:blue and |
| | yellow |
| CdSiO₃:In³⁺ | |
| CdSiO₃:Pb²⁺ | |
| CdSiO₃:Pr³⁺ | |
| CdSiO₃:Sm³⁺ | pink |
| CdSiO₃:RE³⁺ RE:Y/La/Gd/Lu | violet |
| CdSiO₃:RE³⁺ | f(re) |
| CdSiO₃:RE₁³⁺,RE₂³⁺ | f(re) |
| CdSiO₃:Mn²⁺,RE³⁺RE:Y/La/Gd/Lu | orange |
| Ba₂SiO₄:Eu²⁺ | |
| Ba₃SiO₅:Eu²⁺ | |
| MO-M′O—SiO₂:Eu²⁺ | |
| M:Ca/Sr/Ba | |
| M′:Mg/Zn/Cd | blue-yellow f(m,s) |
| or | |
| MO-M′O—SiO₂:Eu²⁺,RE | |
| M:Ca/Sr/Ba,M′:Mg/Zn/Cd | blue-yellow f(m,s) |
| BaMg₂Si₂O₇:Mn²⁺,Eu²⁺,Dy³⁺ | red(mn) |
| BaMg₂Si₂O₇:Mn²⁺,Eu²⁺ (Ba-Defizit) | reddish |
| AMg₂Si₂O₇:Eu²⁺,Mn²⁺ | |
| A = Ba | violet |
| A = Sr | blue |
| A = Ca | yellow |
| Ca₂MgSi₂O₇:Eu²⁺,Dy³⁺ | |
| Sr_{0.5}Ca_{1.5}MgSi₂O₇:Eu²⁺,Dy³⁺ | green |
| (Ca,Sr)₂MgSi₂O₇:Eu²⁺,Dy³⁺ | |
| (Sr,Ca)MgSi₂O₇:Eu²⁺,Dy³⁺ | blue-green |
| Sr₂₋ₓCaₓMgSi₂O₇:Eu²⁺,Dy³⁺ | |
| x = 0 | blue |
| x = 0.5 | blue-green |
| x = 1 | green |
| x = 1.5 | yellow-green |
| x = 2 | yellow |
| x = 0 | |
| x = 0.8 | |
| x = 1.2 | |
| Sr₂MgSi₂O₇:Dy³⁺ | white:blue and |
| | yellow |
| Sr₂MgSi₂O₇:Eu²⁺,Nd³⁺ | blue |
| Sr₂MgSi₂O₇:Eu²⁺,Dy³⁺ | blue |
| Sr₂MgSi₂O₇:Eu²⁺,Dy³⁺ | blue |
| Sr₂₋ₓBaₓMgSi₂O₇:Eu²⁺,Dy³⁺/Nd³⁺,Cl⁻(0 ≦ x ≦ 2) | |
| Sr₃MgSi₂O₈:Eu²⁺,Nd³⁺,Cl⁻ | |
| Ca₂Al₂SiO₇:Mn²⁺,Ce³⁺ | yellow |
| Ca_{0.5}Sr_{1.5}Al₂SiO₇:Ce³⁺,Tb³⁺ | white |
| Sr₃Al₁₀SiO₂₀:Eu²⁺,RE³⁺ | blue |
| (CaO—CaBr₂—SiO₂):Eu²⁺ | green-yellow |
| NaGdGeO₄:Tb³⁺ | green |
| Zn₂GeO₄:Mn²⁺ | green |
| Cd₃Al₂Ge₃O₁₂:RE³⁺ RE:Pr/Tb/Dy | |
| Mg₂SnO₄:Mn²⁺ | green |
| Zn₃(PO₄)₂:Mn²⁺,M³⁺ M:Al,Ga | |
| Zn₃(PO₄)₂:Mn²⁺,Ga³⁺ | red |
| Zn₃(PO₄)₂:Mn_{0.052}²⁺,Ga³⁺ | red |
| Zn₃(PO₄)₂:Mn²⁺,Zr⁴⁺ | red(mn), blue(zr) |
| Zn₃(PO₄)₂:Mn²⁺,Sm³⁺ | red |
| Ba₂TiP₂O₉ | white |
| CaTiO₃:Pr³⁺ | red |
| Ca_{0.8}Zn_{0.2}TiO₃:Pr³⁺ | red |
| Ca₂Zn₄Ti₁₅O₃₆:Pr³⁺ | red |
| Y_{1-y}NbO_{2.5 + 1.5y}:Bi³⁺ (non-stoichiometric) | violet |

The inorganic phosphorescent substances exhibit intense phosphorescence during and after irradiation with visible, or ultra violet light.

In practice either visible light, long-wavelength UV (365 nm, or 395 nm) or short-wavelength UV (254 nm) is generally used to induce phosphorescence. The phosphorescence represents the radiative decay of a triplet excited state to the singlet ground state; this transition is forbidden and the triplet state has a relatively long lifetime, i.e. a decay time above 300 milliseconds.

The particle size of the phosphorescent inorganic pigments is of crucial importance for its characteristics of phosphorescence such as brightness, decay time as well as the printability in case they are incorporated into an ink, or coating. With respect to the phosphorescent inorganic pigment particles to be used, the diameter of 90 percent of the particles (D90) is equal to or less than 25 μm and equal to or more than 0.5 μm.

The decay time of the inorganic phosphorescent substances is dependent on the particle size and the particle size distribution of the substances. The decay time should be preferably in the range of a few seconds.

The phosphorescent inorganic substance is excited by UV light, or by visible light. The visual appearance of the system, comprising the phosphorescent inorganic substance and the transparent colorant, changes by the phosphorescence of the phosphorescent inorganic substance. Within a few seconds the visual appearance reverts back to its original state.

Accordingly, the present invention is also directed to a method for testing an object of value, right, identity, security label, branded good, comprising the step of checking whether a colour shift is present upon irradiation with light.

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLES

### Example 1

### Screen-Printing

A red pigmented concentrate is prepared by mixing 12 parts of red pigment (MICROLITH DPP Red B-K) with 12.3 parts of vinylchlorid/vinylacetat copolymer (VYHH, Union Carbide), 8.8 parts of ethoxy propanol and 66.9 parts of methyl-ethyl-ketone and stirring with a Dispermat apparatus for 15 minutes at 2000 rpm.

A photochromic ink is prepared by mixing 40 parts of a SrAl₂O₄:Eu²⁺ phosphor having a green phosphorescence and a mean particle size of about 3 μm, 52 parts of PRINTCOLOR binder (series 320-05) and 8 parts of the above prepared red concentrate.

Application of the thus obtained ink by screen-printing (Heinrich Mantel, Monolen, 54/67) provides a red uniform print on contrast paper which luminesces under UV light. Red to green photochromic effect is observed under UV light, by partial UV irradiation of the printed surface followed by uncovering of the non-irradiated surface.

### Example 2

### Offset-Printing

An red pigmented concentrate is prepared by mixing 0.5 parts of CROMOPHTAL DPP Red BP with 9.50 parts of E-25736 (binder from Epple) and dispersing in an Engelsmann apparatus with 2 times 50 rotations and 2 kg pressure.

A photochromic ink is prepared by mixing 25 parts of a SrAl₂O₄:Eu²⁺ phosphor having a green phosphorescence and a mean particle size of about 3 μm and 75 parts of the above prepared red concentrate and dispersing is again performed with Engelsmann apparatus with 2 times 50 rotations and 2 kg pressure.

Application of the thus obtained ink by offset-printing (Prüfbau, 800N, 1 m/s) gives a transfer of 1.5 g/m2 on contrast paper as a red uniform print which luminesces strongly under UV light. Red to green photochromic effect is observed under UV light, by partial UV irradiation of the printed surface followed by uncovering of the non-irradiated surface.

### Example 3

### Offset-Printing

A green pigmented concentrate is prepared by mixing 0.5 parts of oleic acid with 5 parts of Chromoxidgruen GN-M and 4.5 parts of E-25736 (binder from Epple) and dispersing in an Engelsmann apparatus with 2 times 50 rotations and 2 kg pressure.

A photochromic ink is prepared by mixing 0.5 parts of a SrAl₂O₄:Eu²⁺ phosphor having a green phosphorescence and a mean particle size of about 3 μm and 2 parts of the above prepared green concentrate and dispersing is again performed with Engelsmann apparatus with 2 times 50 rotations and 2 kg pressure.

Application of the thus obtained ink by offset-printing (Prüfbau, 800N, 1 m/s) gives a transfer of 2.1 g/m² on contrast paper as a green uniform print which luminesces strongly under UV light. A dark green to bright green photochromic effect is observed under UV light, by partial UV irradiation of the printed surface followed by uncovering of the non-irradiated surface.

### Example 4

### Offset-Printing

A black pigmented concentrate is prepared by mixing 0.5 parts of oleic acid with 5 parts of Chromoxidgruen GN-M and 4.5 parts of E-25736 (binder from Epple) and dispersing in an Engelsmann apparatus with 2 times 50 rotations and 2 kg pressure.

A photochromic ink is prepared by mixing 0.5 parts of a SrAl₂O₄:Eu²⁺ phosphor having a green phosphorescence and a mean particle size of about 3 μm and 2 parts of the above prepared black concentrate and dispersing is again performed with Engelsmann apparatus with 2 times 50 rotations and 2 kg pressure.

Application of the thus obtained ink by offset-printing (Prüfbau, 800N, 1 m/s) gives a transfer of 2.5 g/m2 on contrast paper as a black uniform print which luminesces strongly under UV light. Black to green photochromic effect is observed under UV light, by partial UV irradiation of the printed surface followed by uncovering of the non-irradiated surface.

1. A pigment composition, comprising
(A) an inorganic phosphorescent pigment (substance), and
(B) a transparent organic, or inorganic pigment.

2. A coating, or a film material, comprising
(a) a layer, comprising a pigment composition according to claim 1, wherein the pigment composition is present in at least part of said layer; or
(a) a layer, comprising an inorganic phosphorescent pigment, wherein the inorganic phosphorescent pigment is present in at least part of said layer, and
(b) a layer comprising a transparent organic, or inorganic pigment.

3. Security element for a document of value, right, identity, for a security label or a branded good, comprising a substrate, which may contain indicia or other visible features in or on its surface, and on at least part of the said substrate surface,
comprising a pigment composition according to claim 1; or
(a) a coating layer, comprising partially, or fully an inorganic phosphorescent pigment, and
(b) a coating layer, comprising a transparent organic, or inorganic pigment.

4. The pigment composition according to claim 1, wherein the inorganic phosphorescent pigment is selected from CaO:Eu³⁺, CaO:Tb³⁺, SrO:Pb²⁺, SrO:Eu³⁺, SrO:Tb³⁺, BaO:Eu³⁺, Y₂O₂S:Ti⁴⁺, Mg^{2+,} (Y_{2-x-y}TixMg_{y})O₂S, Y₂O₂S:Sm²⁺, Ti⁴⁺, Mg²⁺, Y₂O₂S:Eu³⁺, Ti⁴⁺, Mg²⁺, Y₂O₂S:Tm³⁺, Ti⁴⁺, Mg²⁺, Y₂O₂S:Yb³⁺, Ti⁴⁺, Mg²⁺, Y₂O₂S:Eu³⁺, Ti⁴⁺, Y₂O₂S, Y₂O₂S:RE³⁺ (RE:Lu/Gd), Y₂O₂S:Tb³⁺, Sr²⁺ and/or Zr⁴⁺, Y₂O₂S:Tm³⁺, Gd₂O₂S:Er³⁺, Ti⁴⁺, CaS:Eu²⁺, Ce³⁺, CaS:Eu²⁺, Sm³⁺, CaS:Eu²⁺, Tm³⁺, CaS:Eu²⁺, Tm³⁺, Ce³⁺, (Ca,Sr)S:Bi³⁺, CaGa₂S₄:Eu²⁺, Ho³⁺, CaGa₂S₄:Eu²⁺, RE^{3+,} (RE: Y/Ce/Pr/Gd/Tb/Ho), SrS:Eu²⁺, Y³⁺, Ce³⁺, ZnS:Cu, ZnS:Cu, Co, Zn₄O(BO₂)₆, CaAl₂B₂O₇:Eu²⁺, Nd³⁺, MgAl₂O₄:Ce³⁺, CaAl₂O₄:Mn²⁺, Ce³⁺, CaAl₂O₄:Eu²⁺, Nd³⁺, Ca_{1-x-y}Al₂O₄:Euₓ²⁺ Nd_{y}³⁺, (0≦x≦0.045; 0≦y≦0.0037), opt.: x=0.00125; y=0.0025, CaAl₂O₄:Eu²⁺, Nd³⁺, CaAl₂O₄ Eu²⁺, Nd³⁺, La³⁺, CaAl₄O7:Eu²⁺, Nd³⁺, Ca1−xSrxAl₂O₄:Eu²⁺, Nd³⁺, La³⁺, SrAl₂O₄:Ce³⁺, SrAl₂O₄:Eu²⁺, SrAl₂O₄:Eu²⁺, B³⁺, SrAl₂O₄:Eu²⁺, Nd³⁺, SrAl₂O₄:Eu²⁺, Dy³⁺MAl₂O₄:Eu²⁺, Dy³⁺M:Sr, (Ba/Ca) or M:Sr,Ba,Ca, Sr₄Al₁₄O₂₅:Eu²⁺, RE³⁺ RE:Dy/Pr/Ho/Nd and/or Sm, Sr₄Al₁₄O₂₅:Cr³⁺, Eu²⁺, Dy³⁺, Sr₅Al₂O₇S :Eu²⁺, Y₃Ga₅O₁₂:Cr³⁺, MgSiO₃:Mn²⁺, Eu²⁺, Dy³⁺, SrSiO₃:Dy³⁺ CdSiO₃:In³⁺, CdSiO₃:Pb²⁺, CdSiO₃:Pr³⁺, CdSiO₃:Sm³⁺, CdSiO₃:RE³⁺ RE:Y/La/Gd/Lu, CdSiO₃:RE³⁺, CdSiO₃:RE₁³⁺, RE₂³⁺, CdSiO₃:Mn²⁺, RE³⁺ RE:Y/La/Gd/Lu, Ba₂SiO₄:Eu²⁺, Ba₃SiO₅:Eu²⁺, MO-M′O—SiO₂:Eu²⁺, M:Ca/Sr/Ba, M′:Mg/Zn/Cd, or, MO-M′O—SiO₂:Eu²⁺, RE, M:Ca/Sr/Ba, M′:Mg/Zn/Cd, BaMg₂Si₂O₇:Mn²⁺, Eu²⁺, Dy³⁺, BaMg₂Si₂O₇:Mn²⁺, Eu²⁺ (Ba-Defizit), AMg₂Si₂O₇:Eu²⁺, Mn²⁺, A=Ba, A=Sr, A=Ca, Ca₂MgSi₂O₇:Eu²⁺, Dy³⁺, Sr_{0.5}Ca_{1.5}MgSi₂O₇: Eu²⁺, Dy³⁺, (Ca,Sr)₂MgSi₂O₇:Eu²⁺, Dy³⁺, (Sr,Ca)MgSi₂O₇:Eu²⁺, Dy³⁺, Sr₂₋ₓCaₓMgSi₂O₇:Eu²⁺, Dy³⁺, x=0, x=0.5, x=1, x=1.5, x=2, x=0, x=0.8, x=1,2, Sr₂MgSi₂O₇:Dy³⁺, Sr₂MgSi₂O₇:Eu²⁺, Nd³⁺, Sr₂MgSi₂O₇:Eu²⁺, Dy³⁺, Sr₂MgSi₂O₇:Eu²⁺, Dy³⁺, Sr₂₋ₓBaₓMgSi₂O₇:Eu²⁺, Dy³⁺/Nd³⁺, Cl⁻(0≦x≦2), Sr₃MgSi₂O₈:Eu²⁺, Nd³⁺, Cl⁻, Ca₂Al₂SiO₇:Mn²⁺, Ce³⁺, Ca_{0.5}Sr_{1.5}Al₂SiO₇:Ce³⁺, Tb³⁺, Sr₃Al₁₀SiO₂₀:Eu²⁺, RE³⁺, (CaO—CaBr₂—SiO₂):Eu²⁺, NaGdGeO₄:Tb³⁺, Zn₂GeO₄:Mn²⁺, Cd₃Al₂Ge₃O₁₂:RE³⁺ RE:Pr/Tb/Dy, Mg₂SnO₄:Mn²⁺, Zn₃(PO₄)₂:Mn²⁺, M³⁺M:Al, Ga, Zn₃(PO₄)₂:Mn²⁺³⁺, Ga³⁺, Zn₃(PO₄)₂:Mn_{0.052}²⁺, Ga³⁺, Zn₃(PO₄)₂:Mn²⁺, Zr⁴⁺, Zn₃(PO₄)₂:Mn²⁺, Ba₂TiP₂O₉, CaTiO₃:Pr³⁺, Ca_{0.8}Zn_{0.2}TiO₃:Pr³⁺, Ca₂Zn₄Ti₁₅O₃₆:Pr³⁺, and Y_{1-y}NbO_{2,5+1,5y}:Bi³⁺ (non-stoichiometric).

5. The pigment composition according to claim 1, wherein the transparent colorant is an inorganic pigment selected from the group consisting of transparent yellow iron oxide [C.I. Pigment Yellow 42:77 492], transparent red iron oxide [C.I. Pigment Red 101:77 491], transparent Cobalt Blue [C.I. Pigment Blue 28: 77 346], transparent Cobalt Green [C.I. Pigment Green 19:77 335] and transparent chrome oxide green.

6. The pigment composition according to claim 1, wherein the transparent colorant is an organic pigment selected from the group consisting of a transparent quinacridone in its magenta and red colors, a transparent yellow isoindolinone pigment, a transparent yellow quinacridone/quinacridonequinone solid solution, a transparent copper phthalocyanine blue a halogenated copper phthalocyanine green, a highly-saturated transparent diketopyrrolopyrrole pigment and a dioxazine pigment.

7. The pigment composition according to claim 1, wherein the transparent colorant is chrome oxide green, or a diketopyrrolopyrrole pigment and the inorganic phosphorescent pigment is a SrAl₂O₄:Eu²⁺ phosphor having a green phosphorescence and a mean particle size of about 3 μm.

8. A method of producing a security element according to claim 3, comprising the steps of
a) providing a substrate having a surface, which surface may contain indicia or other visible features;
b) applying, on top of at least part of the said substrate surface a coating, comprising an inorganic phosphorescent pigment, a transparent colorant and a curable transparent binder, and
(c) curing said coating layer; or
a) providing a substrate having a surface, which surface may contain indicia or other visible features;
b) applying, on top of at least part of the said substrate surface a coating, comprising an inorganic phosphorescent pigment and a curable transparent binder,
b1) optionally curing said coating layer (b);
b2) applying, on top of said coating layer (b) a coating, comprising an inorganic phosphorescent pigment (substance) and a curable transparent binder, and
(c) curing said coating layer(s).

9. A phosphorescent image formed by printing an inorganic phosphorescent pigment, and a transparent colorant on a substrate, comprising a phosphorescent image-forming layer on said substrate, or a phosphorescent image-forming layer and a colored transparent layer on said substrate, wherein
the phosphorescent image-forming layer comprises an inorganic phosphorescent pigment and optionally a transparent colorant, and
the colored transparent layer comprises a transparent colorant.

10. Document of value, right, identity, security label, branded good, comprising a security element according to claim 3.

11. (canceled)

12. A method for testing an object of value, right, identity, security label, branded good, comprising the step of incorporating a security element according to claim 3 and the step of checking whether a colour shift is present upon irradiation with light.

13. The security element according to claim 3, wherein the inorganic phosphorescent pigment is selected from CaO:Eu³⁺, CaO:Tb³⁺, SrO:Pb²⁺, SrO:Eu³⁺, SrO:Tb³⁺, BaO:Eu³⁺, Y₂O₂S:Ti⁴⁺, Mg^{2+,} (Y_{2-x-y}TixMg_{y})O₂S, Y₂O₂S:Sm²⁺, Ti⁴⁺, Mg²⁺, Y₂O₂S:Eu³⁺, Ti⁴⁺, Mg²⁺, Y₂O₂S: Tm³⁺, Ti⁴⁺, Mg²⁺, Y₂O₂S:Yb³⁺, Ti⁴⁺, Mg²⁺, Y₂O₂S:Eu³⁺, Ti⁴⁺, Y₂O₂S, Y₂O₂S:RE³⁺ (RE:Lu/Gd), Y₂O₂S:Tb³⁺, Sr²⁺and/or Zr⁴⁺, Y₂O₂S:Tm³⁺, Gd₂O₂S:Eu³⁺, Ti⁴⁺, CaS:Eu²⁺, Ce³⁺, CaS:Eu²⁺, Sm³⁺, CaS:Eu²⁺, Tm³⁺, CaS:Eu²⁺, Tm³⁺, Ce³⁺, (Ca,Sr)S:Bi³⁺, CaGa₂S₄:Eu²⁺, Ho³⁺, CaGa₂S₄:Eu²⁺, RE^{3+,} (RE:Y/Ce/Pr/Gd/Tb/Ho), SrS:Eu²⁺, Y³⁺, Ce³⁺, ZnS:Cu, ZnS:Cu, Co, Zn₄O(BO₂)₆, CaAl₂B₂O₇:Eu²⁺, Nd³⁺, MgAl₂O₄:Ce³⁺, CaAl₂O₄:Mn²⁺, Ce³⁺, CaAl₂O₄:Eu²⁺, Nd³⁺, Ca_{1-x-y}Al₂O₄:Euₓ²⁺, Nd_{y}³⁺, (0≦x0.045; 0≦y≦0.0037), opt.: x=0.00125; y=0.0025, CaAl₂O₄:Eu²⁺, Nd³⁺, CaAl₂O₄:Eu²⁺, Nd³⁺, La³⁺, CaAl₄O7:Eu²⁺, Nd³⁺, Ca1−xSrxAl₂O₄:Eu²⁺, Nd³⁺, La³⁺, SrAl₂O₄:Ce³⁺, SrAl₂O₄:Eu²⁺, SrAl₂O₄:Eu²⁺, B³⁺, SrAl₂O₄:Eu²⁺, Nd³⁺, SrAl₂O₄:Eu²⁺, Dy³⁺MAl₂O₄:Eu²⁺, Dy³⁺ M:Sr, (Ba/Ca) or M:Sr,Ba,Ca, Sr₄Al₁₄O₂₅:Eu²⁺, RE³⁺ RE:Dy/Pr/Ho/Nd and/or Sm, Sr₄A1₁₄O₂₅:Cr³⁺, Eu²⁺, Dy³⁺, Sr₅Al₂O₇S :Eu²⁺, Y₃Ga₅O₁₂:Cr³⁺, MgSiO₃:Mn²⁺,Eu²⁺,Dy³⁺, SrSiO₃:Dy³⁺, CdSiO₃:In³⁺, CdSiO₃:Pb²⁺, CdSiO₃:Pr³⁺, CdSiO₃:Sm³⁺, CdSiO₃:RE³⁺ RE:Y/La/Gd/Lu, CdSiO₃:RE³⁺, CdSiO₃:RE₁³⁺, RE₂³⁺, CdSiO₃:Mn²⁺, RE³⁺ RE:Y/La/Gd/Lu, Ba₂SiO₄:Eu²⁺, Ba₃SiO₅:Eu²⁺, MO_M′O—SiO₂:Eu²⁺, M:Ca/Sr/Ba, M′:Mg/Zn/Cd, or, MO-M′O—SiO₂:Eu²⁺, RE, M:Ca/Sr/Ba, M′:Mg/Zn/Cd, BaMg₂Si₂O₇:Mn²⁺, Eu²⁺, Dy³⁺, BaMg₂Si₂O₇:Mn²⁺, Eu²⁺ (Ba-Defizit), AMg₂Si₂O₇:Eu²⁺, Mn²⁺, A=Ba, A=Sr, A=Ca, Ca₂MgSi₂O₇:Eu²⁺, Dy³⁺, Sr_{0.5}Ca_{1.5}MgSi₂O₇:Eu²⁺, Dy³⁺, (Ca,Sr)₂MgSi₂O₇:Eu²⁺, Dy³⁺, (Sr,Ca)MgSi₂O₇:Eu²⁺, Dy³⁺, Sr₂₋ₓCaₓMgSi₂O₇:Eu²⁺, Dy³⁺, x=0, x=0.5, x=1, x=1.5, x=2, x=0, x=0.8, x=1,2, Sr₂MgSi₂O₇:Dy³⁺, Sr₂MgSi₂O₇:Eu²⁺, Nd³⁺, Sr₂MgSi₂O₇:Eu²⁺, Dy³⁺, Sr₂MgSi₂O₇:Eu²⁺, Dy³⁺, Sr₂₋ₓBaₓMgSi₂O₇:Eu²⁺, Dy³⁺/Nd³⁺, Cl⁻ (0≦x≦2), Sr₃MgSi₂O₈:Eu²⁺, Nd³⁺, Cl⁻, Ca₂Al₂SiO₇:Mn²⁺, Ce³⁺, Ca_{0.5}Sr_{1.5}Al₂SiO₇:Ce³⁺, Tb³⁺, Sr₃Al₁₀SiO₂₀:Eu²⁺, RE³⁺, (CaO—CaBr₂—SiO₂):Eu²⁺, NaGdGeO₄: Tb³⁺, Zn₂GeO₄:Mn²⁺, Cd₃Al₂Ge₃O₁₂:RE³⁺ RE:Pr/Tb/Dy, Mg₂SnO₄:Mn²⁺, Zn₃(PO₄)₂:Mn²⁺, M³⁺ M:Al, Ga, Zn₃(PO₄)₂:Mn²⁺, Ga³⁺, Zn₃(PO₄)₂:Mn_{0.052}²⁺, Ga³⁺, Zn₃(PO₄)₂:Mn²⁺, Zr⁴⁺, Zn₃(PO₄)₂:Mn²⁺, Sm³⁺, Ba₂TiP₂O₉, CaTiO₃:Pr³⁺, Ca_{0.8}Zn_{0.2}TiO₃:Pr³⁺, Ca₂Zn₄Ti₁₅O₃₆:Pr³⁺, and Y_{1-y}NbO_{2.5+1,5}y:Bi³⁺ (non-stoichiometric).

14. The security element according to claim 3, wherein the transparent colorant is an inorganic pigment selected from the group consisting of transparent yellow iron oxide [C.I. Pigment Yellow 42:77 492], transparent red iron oxide [C.I. Pigment Red 101:77 491], transparent Cobalt Blue [C.I. Pigment Blue 28: 77 346], transparent Cobalt Green [C.I. Pigment Green 19:77 335] and transparent chrome oxide green.

15. The security element according to claim 3, wherein the transparent colorant is an organic pigment selected from the group consisting of a transparent quinacridone in its magenta and red colors, a transparent yellow isoindolinone pigment, a transparent yellow quinacridone/quinacridonequinone solid solution, a transparent copper phthalocyanine blue a halogenated copper phthalocyanine green, a highly-saturated transparent diketopyrrolopyrrole pigmen and a dioxazine pigment.

16. The security element according to claim 3, wherein the transparent colorant is chrome oxide green, or a diketopyrrolopyrrole pigment and the inorganic phosphorescent pigment is a SrAl₂O₄:Eu²⁺ phosphor having a green phosphorescence and a mean particle size of about 3 μm.

17. The coating or film material according to claim 2, wherein the inorganic phosphorescent pigment is selected from CaO:Eu³⁺, CaO:Tb³⁺, SrO:Pb²⁺, SrO:Eu³⁺, SrO:Tb³⁺, BaO:Eu³⁺, Y₂O₂S:Ti⁴⁺, Mg²⁺′ (Y_{2-x-y}TixMg_{y})O₂S, Y₂O₂S:Sm²⁺, Ti⁴⁺, Mg²⁺, Y₂O₂S:Eu³⁺, Ti⁴⁺, Mg²⁺, Y₂O₂S:Tm³⁺, Ti⁴⁺, Mg²⁺, Y₂O₂S:Yb³⁺, Ti⁴⁺, Mg²⁺, Y₂O₂S:Eu³⁺, Ti⁴⁺, Y₂O₂S, Y₂O₂S:RE³⁺ (RE:Lu/Gd), Y₂O₂S:Tb³⁺, Sr²⁺ and/or Zr⁴⁺, Y₂O₂S:Tm³⁺, Gd₂O₂S:Er³⁺, Ti⁴⁺, CaS:Eu²⁺, Ce³⁺, CaS: Eu²⁺, Sm³⁺, CaS:Eu²⁺, Tm³⁺, CaS:Eu²⁺, Tm³⁺, Ce³⁺, (Ca,Sr)S:Bi³⁺, CaGa₂S₄:Eu²⁺, Ho³⁺, CaGa₂S₄:Eu²⁺, RE^{3+,} (RE:Y/Ce/Pr/Gd/Tb/Ho), SrS:Eu²⁺, Y³⁺, Ce³⁺, ZnS:Cu, ZnS:Cu, Co, Zn₄O(BO₂)₆, CaAl₂B₂O₇:Eu²⁺, Nd³⁺, MgAl₂O₄:Ce³⁺, CaAl₂O₄:Mn²⁺, Ce³⁺, CaAl₂O₄:Eu²⁺, Nd³⁺, Ca_{1-x-y}Al₂O₄:Euₓ²⁺, Nd_{y}³⁺, (0≦x≦0.045; 0≦y≦0.0037), opt.: x=0.00125; y=0.0025, CaAl₂O₄: Eu²⁺, Nd³⁺, CaAl₂O₄:Eu²⁺, Nd³⁺, La³⁺, CaAl₄O7:Eu²⁺, Nd³⁺, Ca1−xSrxAl₂O₄:Eu²⁺, Nd³⁺, La³⁺, SrAl₂O₄:Ce³⁺, SrAl₂O₄:Eu²⁺, SrAl₂O₄:Eu²⁺, B³⁺, SrAl₂O₄:Eu²⁺, Nd³⁺, SrAl₂O₄:Eu³⁺, Dy³⁺, MAl₂O₄:Eu²⁺, Dy³⁺M:Sr, (Ba/Ca) or M:Sr,Ba,Ca, Sr₄Al₁₄O₂₅:Eu²⁺, RE³⁺ RE:Dy/Pr/Ho/Nd and/or Sm, Sr₄Al₁₄O₂₅:Cr³⁺, Eu²⁺, Dy³⁺, Sr₅Al₂O₇S:Eu²⁺, Y₃Ga₅O₁₂:Cr³⁺, MgSiO₃:Mn²⁺, Eu²⁺, Dy³⁺, SrSiO₃:Dy³⁺, CdSiO₃:In³⁺, CdSiO₃:Pb²⁺, CdSiO₃:Pr³⁺, CdSiO₃:Sm³⁺, CdSiO₃:RE³⁺ RE:Y/La/Gd/Lu, CdSiO₃:RE³⁺, CdSiO₃:RE₁³⁺, RE₂³⁺, CdSiO₃:Mn²⁺, RE³⁺ RE:Y/La/Gd/Lu, Ba₂SiO₄:Eu²⁺, Ba₃SiO₅:Eu²⁺, MO-M′O—SiO₂:Eu²⁺, M:Ca/Sr/Ba, M′:Mg/Zn/Cd, or, MO-M′O—SiO₂:Eu²⁺, RE, M:Ca/Sr/Ba, M′:Mg/Zn/Cd, BaMg₂Si₂O₇:Mn²⁺, Eu²⁺, Dy³⁺, BaMg₂Si₂O₇:Mn²⁺, Eu²⁺ (Ba-Defizit), AMg₂Si₂O₇:Eu²⁺, Mn²⁺, A=Ba, A=Sr, A=Ca, Ca₂MgSi₂O₇:Eu²⁺, Dy³⁺, Sr_{0.5}Ca_{1.5}MgSi₂O₇:Eu²⁺, Dy³⁺, (Ca,Sr)₂MgSi₂O₇:Eu²⁺, Dy³⁺, (Sr,Ca)MgSi₂O₇:Eu²⁺, Dy³⁺, Sr₂₋ₓCaₓMgSi₂O₇:Eu²⁺, Dy³⁺, x=0, x=0.5, x=1, x=1.5, x=2, x=0, x=0.8, x=1,2, Sr₂MgSi₂O₇:Dy³⁺, Sr₂MgSi₂O₇:Eu²⁺, Nd³⁺, Sr₂MgSi₂O₇:Eu²⁺, Dy³⁺, Sr₂MgSi₂O₇:Eu²⁺, Dy³⁺, Sr₂₋ₓBaₓMgSi₂O₇:Eu²⁺, Dy³⁺/Nd³⁺, Cl⁻(0≦x≦2), Sr₃MgSi₂O₈:Eu²⁺, Nd³⁺, Cl⁻, Ca₂Al₂SiO₇:Mn²⁺, Ce³⁺, Ca_{0.5}Sr_{1.5}Al₂SiO₇:Ce³⁺, Tb³⁺, Sr₃Al₁₀SiO₂₀:Eu²⁺, RE³⁺, (CaO—CaBr₂—SiO₂):Eu²⁺, NaGdGeO₄:Tb³⁺, Zn₂GeO₄:Mn²⁺, Cd₃Al₂Ge₃O₁₂:RE³⁺ RE:Pr/Tb/Dy, Mg₂SnO₄:Mn²⁺, Zn₃(PO₄)₂:Mn²⁺, M³⁺30 M:Al, Ga, Zn₃(PO₄)₂:Mn²⁺, Ga³⁺, Zn₃(PO₄)₂:Mn_{0.052}²⁺, Ga³⁺, Zn₃(PO₄)₂:Mn²⁺, Zr⁴⁺, Zn₃(PO₄)₂Mn²⁺, Sm³⁺, Ba₂TiP₂O₉, CaTiO₃:Pr³⁺, Ca_{0.8}Zn_{0.2}TiO₃:Pr³⁺, Ca₂Zn₄Ti₁₅O₃₆:Pr³⁺, and Y_{1-y}NbO_{2.5+1.5y}:Bi³⁺ (non-stoichiometric).

18. The coating or film material according to claim 2, wherein the transparent colorant is an inorganic pigment selected from the group consisting of transparent yellow iron oxide [C.I. Pigment Yellow 42:77 492], transparent red iron oxide [C.I. Pigment Red 101:77 491], transparent Cobalt Blue [C.I. Pigment Blue 28: 77 346], transparent Cobalt Green [C.I. Pigment Green 19:77 335] and transparent chrome oxide green.

19. The coating or film material according to claim 2, wherein the transparent colorant is an organic pigment selected from the group consisting of a transparent quinacridone in its magenta and red colors, a transparent yellow isoindolinone pigment, a transparent yellow quinacridone/quinacridonequinone solid solution, a transparent copper phthalocyanine blue a halogenated copper phthalocyanine green, a highly-saturated transparent diketopyrrolopyrrole pigmen and a dioxazine pigment.

20. The coating or film material according to claim 2, wherein the transparent colorant is chrome oxide green, or a diketopyrrolopyrrole pigment and the inorganic phosphorescent pigment is a SrAl₂O₄:Eu²⁺ phosphor having a green phosphorescence and a mean particle size of about 3 μm.
